(19) United States
(12) Patent Application Publication
(10) Pub. No.: US 2024/0103175 A1
(43) Pub. Date: Mar. 28, 2024

(54) IMAGING SYSTEM

(71) Applicant: LightCode Photonics OÜ, Tartu (EE)

(72) Inventors: ANDREAS VALDMANN, Tartu (EE); HELI VALTNA, Tartu (EE); JAN BOGDANOV, Tartu (EE); SERGEY OMELKOV, Tartu (EE); JASON SHAWN LEE EXLEY, Tartu (EE)

(73) Assignee: LightCode Photonics OÜ, Tartu (EE)

(21) Appl. No.: 18/254,359

(22) PCT Filed: Nov. 24, 2021
(86) PCT No.: PCT/EP2021/082877

§ 371 Date: May 24, 2023

(30) Foreign Application Priority Data
Nov. 25, 2020 (GB) 2018504.7

(51) Int. Cl. G01S 17/894; G01S 7/481; G01S 17/10; G01S 17/42; G01S 17/931

(52) U.S. Cl. CPC G01S 17/894; G01S 7/4817; G01S 17/10; G01S 17/42; G01S 17/931

(57) ABSTRACT

A method of imaging a scene comprises illuminating the scene using a sequence of illumination patterns, and using a sensor to detect reflections from the scene in respect of each illumination pattern of the sequence. The sequence of illumination patterns is configured to allow a first image of the scene having a first resolution to be constructed. The sequence of illumination patterns includes a first sub-set of illumination patterns, wherein the first sub-set of illumination patterns is configured to allow a second image of the scene having a second resolution to be constructed. The method further comprises using detected reflections in respect of the illumination patterns of the sequence to construct a first image of the scene having the first resolution, and using detected reflections in respect of the first sub-set of illumination patterns to construct a second image of the scene.

The technology described herein relates generally to methods of imaging, image reconstruction algorithms, and imaging systems, such as for example methods of LiDAR (Light Detection and Ranging) imaging and LiDAR imaging systems.

Self-driving vehicles and driver assistance systems are currently being developed for passenger and cargo mobility. Self-driving vehicles utilise 3D-imaging methods to create a precise real-time 3D map for navigation. An ideal automotive imaging system would combine the following features: long range, wide field of view, high imaging resolution in all three axes, high frame rate, high dynamic range (contrast), compliance to laser safety standards, compact size, and low cost.

Many of these criteria are interlinked or even mutually exclusive. For example, as the back-reflected light intensity decreases proportionally to the square of the object distance, improving the range of the system would entail either increasing the emitted light power (restricted by laser safety), increasing the integration time (which lowers the frame rate), using larger optics to collect more light (increases the size and cost of the system), or dealing with a noisier signal (lowers the dynamic range and can produce artefacts). Therefore, existing LiDAR designs make compromises to meet some of these requirements, while sacrificing others.

It is possible to use different 3D-imaging systems simultaneously, e.g., a narrow field of view long range system and a wide angle short range system. However, this increases the cost and complexity of the sensor package, and is only viable in the testing stage of autonomy platforms, where these criteria are less restrictive than in case of mass-produced vehicles. Another possibility is to make some parts of the system switchable between different modes. For example, variable optics similar to a zoom lens could be used to change the field of view of the system. This, however, means that the end user or the autonomy system has to decide on which is the best mode for the current situation, and vital information may be lost when operating in a non-optimal mode (e.g., if the field of view is set in the narrow mode, a threat emerging from the side may be missed).

Hence, a truly adaptive system is needed that can operate in different acquisition modes simultaneously, ensuring that reliable and optimal data is output to the user at all times.

The Applicant believes that there remains scope for improvements to methods of imaging and to imaging systems.

According to a first aspect, there is provided a method of imaging a scene, the method comprising:
illuminating a scene using a sequence of illumination patterns; and
using a sensor to detect reflections from the scene in respect of each illumination pattern of the sequence;
wherein the sequence of illumination patterns is configured to allow a first image of the scene having a first resolution to be constructed, wherein the first resolution is greater than the resolution of the sensor;
wherein the sequence of illumination patterns includes a first sub-set of illumination patterns, wherein the first sub-set of illumination patterns is configured to allow a second image of the scene having a second resolution to be constructed, and wherein the second resolution is less than the first resolution; and
wherein the method further comprises:
using detected reflections in respect of the illumination patterns of the sequence to construct a first image of the scene having the first resolution; and
using detected reflections in respect of the first sub-set of illumination patterns to construct a second image of the scene having the second resolution.

According to a second aspect, there is provided an imaging system comprising:
one or more sources configured to illuminate a scene using a sequence of illumination patterns; and
a sensor configured to detect reflections from the scene in respect of each illumination pattern of the sequence;
wherein the sequence of illumination patterns is configured to allow a first image of the scene having a first resolution to be constructed, wherein the first resolution is greater than the resolution of the sensor;
wherein the sequence of illumination patterns includes a first sub-set of illumination patterns, wherein the first sub-set of illumination patterns is configured to allow a second image of the scene having a second resolution to be constructed, and wherein the second resolution is less than the first resolution; and
wherein the system further comprises a processing circuit configured to:
use detected reflections in respect of the illumination patterns of the sequence to construct a first image of the scene having the first resolution; and
use detected reflections in respect of the first sub-set of illumination patterns to construct a second image of the scene having the second resolution.

According to a third aspect, there is provided an image processing system comprising:
a processing circuit configured to control one or more sources so as to illuminate a scene using a sequence of illumination patterns; and
a processing circuit configured to receive information from a sensor that is configured to detect reflections from the scene in respect of each illumination pattern of the sequence;
wherein the sequence of illumination patterns is configured to allow a first image of the scene having a first resolution to be constructed, wherein the first resolution is greater than the resolution of the sensor;
wherein the sequence of illumination patterns includes a first sub-set of illumination patterns, wherein the first sub-set of illumination patterns is configured to allow a second image of the scene having a second resolution to be constructed, and wherein the second resolution is less than the first resolution; and
wherein the system further comprises a processing circuit configured to:
use detected reflections in respect of the illumination patterns of the sequence to construct a first image of the scene having the first resolution; and
use detected reflections in respect of the first sub-set of illumination patterns to construct a second image of the scene having the second resolution.

The technology described herein is concerned with a method of imaging a scene (and an imaging system) in which the scene is illuminated using a sequence of illumination patterns, and reflections from the scene are detected in respect of each illumination pattern of the sequence. In the technology described herein, the sequence of illumination patterns is configured to allow an image of the scene having a first resolution to be constructed, where the first resolution is greater than the resolution of the sensor used to detect the reflections, and a first image of the scene having the first resolution is constructed using detected reflections in respect of the illumination patterns of the sequence.

In addition to this (and in contrast to known techniques), in the technology described herein, the sequence of illumination patterns is arranged to include a first sub-set of illumination patterns (e.g. that may appear in the sequence before the end of the sequence), where the first sub-set of illumination patterns is configured to allow a second image of the scene having a second resolution to be constructed, with the second resolution being less than the first resolution (and optionally greater than the resolution of the sensor), and a second image of the scene is constructed using detected reflections in respect of the illumination patterns of the first sub-set.

As will be described in more detail below, the Applicant has recognised that in addition to a first (e.g. “full” or “high” resolution) image of the scene that can be constructed using a sequence of illumination patterns, a second lower resolution image of the scene can be constructed using a sub-set of (i.e. less than all) patterns of the sequence.

Furthermore, and as will be described in more detail below, the so-produced second image can be used, e.g. to control the remaining illumination patterns in the sequence of illumination patterns and/or to control a subsequent sequence of illumination patterns. This in turn can provide significantly improved flexibility and control over the imaging process.

It will be appreciated, therefore, that the technology described herein provides an improved method of imaging a scene, and an improved imaging system.

The one or more sources may comprise any suitable electromagnetic radiation (e.g. light) source(s) capable of illuminating the scene with a sequence of (different) illumination patterns.

The one or more sources will have some (maximum) field of view (e.g. solid angle which the source(s) is capable of illuminating), and may be configured to illuminate parts of a scene within its field of view. The one or more sources may be configured such that the field of view has a fixed or variable orientation and/or size.

The or each source may comprise any suitable source of electromagnetic radiation, such as for example a laser, e.g. a pulsed laser.

The imaging system may comprise a single source or plural sources.

In various particular embodiments, the one or more sources comprises an array of plural electromagnetic radiation (e.g. light) sources, such as a 1D (line) array or a 2D array of electromagnetic radiation (e.g. light) sources. Suitable sources for constructing an array include, for example, solid state lasers such as vertical-cavity surface-emitting lasers (VCSELs). The array can have any desired configuration, such as being a regular array (such as a square or rectangular array), or an irregular array, etc.

In these embodiments, the sources in the array may have the same orientation as one another (e.g. perpendicular to a plane of the array), and/or each source may have a fixed orientation within the array. Each source of the array may be independently controllable, such that each source can be used to selectively illuminate (different parts of) the scene (i.e. so as to be turned on or off). Different illumination patterns may then be formed by controlling the array such that different sources of the array are on/off in respect of each different pattern.

In various other embodiments, the one or more sources may comprise one or more sources (such as a single source) configured such that the electromagnetic radiation (e.g. light) emitted by the source has a variable orientation. For example, the orientation of the source itself may be variable, or a mirror may be used to vary the orientation of the electromagnetic radiation (e.g. light) emitted by the source.

In these embodiments, the orientation of the electromagnetic radiation may be controllable (and one or more or each source may be independently controllable (i.e. so as to be turned on or off)), such that the or each source can be used to selectively illuminate (different parts of) the scene. Different illumination patterns may be formed by controlling the orientation of the electromagnetic radiation (e.g. by scanning the source and/or mirror) such that different parts of the scene are illuminated/not illuminated in respect of each different pattern.

Thus, the one or more sources may comprise a multi-pixel source, or a scanning source.

Various other embodiments are possible. For example, it would be possible to construct a multi-pixel source using one or more electromagnetic radiation sources together with an array of mirrors. It would also be possible for the one or more sources to comprise a holographic source.

The sensor may comprise any suitable electromagnetic radiation (e.g. light) sensor capable of detecting reflections from the scene (of the electromagnetic radiation (e.g. light) emitted from the one or more sources). The sensor may comprise, for example one or more photodiodes, a charged-couple device (CCD), etc.

The sensor(s) has a particular resolution, i.e. (total) number of pixels P (where P is a positive integer). The sensor may be a single pixel sensor (P=1) or a multi-pixel sensor (P>1).

In various particular embodiments, the sensor comprises an array of plural pixels, such as a 1D (line) array or a 2D array of pixels. The array can have any desired configuration, such as being a regular array (such as a square or rectangular array), or an irregular array, etc.

The array may comprise, for example, a single-photon sensitive solid-state detector array, such as a single photon avalanche diode (SPAD) array, or a Geiger mode avalanche photodiode (GmAPD) array. Other arrangements would, of course, be possible.

The sensor is configured to detect reflections from the scene in respect of each illumination pattern of the sequence. Thus, the sensor may be configured to capture a sequence of images (of the reflected electromagnetic radiation), where each captured image respectively corresponds (only) to a single illumination pattern of the sequence of illumination patterns. To do this, the imaging system may be configured such that operation of the sensor and the one or more sources are appropriately synchronised.

In the technology described herein, the scene is illumined with a sequence of illumination patterns. That is, the scene is illuminated with each pattern of a sequence of (different) illumination patterns in turn (one by one).

An illumination pattern is an illumination intensity distribution within the field of view of the (one or more sources of the) imaging system.

An illumination pattern may be binary, i.e. having two different illumination levels (e.g., illuminated and non-illuminated regions). Alternatively, an illumination pattern may be multi-level, i.e. containing a discrete number of different illumination levels. Alternatively, an illumination pattern may be continuous, where the illumination intensity smoothly varies between different regions of the field of view.

Each illumination pattern may, in effect, be a two dimensional intensity distribution pattern, e.g. may be capable of being described by a two dimensional pattern. For example, the illumination distribution of an illumination pattern may be defined e.g., on a discrete grid, in a discrete number of spatial points that may or may not be distributed regularly in the field of view; or as a mathematical function of non-discrete spatial coordinates in the field of view.

Each pattern in the sequence may be different from each other pattern in the sequence, i.e. in terms of the illumination intensity distribution within the field of view of the (one or more sources of the) imaging system. However, it would also be possible for some of the patterns to be repeated in the sequence (and in some embodiments, this is the case).

In the technology described herein, the sequence of illumination patterns is configured to allow a first image of the scene having a first resolution to be constructed, and a first image of the scene that has the first resolution is constructed using the detected reflections (e.g. captured images) in respect of some or all of the illumination patterns of the sequence, where the first resolution is greater than the resolution of the sensor.

The first resolution may comprise any suitable (“high”) resolution that is greater than the resolution of the detector. The first resolution may be greater than the resolution of the detector in at least one, such as in two (both), dimensions. In general, the first image may comprise a W×H resolution image, i.e. having W*H=M total pixels (where W, H and M are each positive integers), where M>P. The first resolution may, for example, be a maximum (“full”) resolution of the imaging system.

The skilled person will understand that illuminating the scene with a sequence of different illumination patterns and recording images for each pattern, in accordance with various embodiments, can enable the effective resolution of an image constructed using the combined images to be higher than the native resolution of the detector. As will be understood by the skilled person, this can be achieved e.g. using so-called computational ghost imaging (CGI) (and other related) techniques.

As used herein, a “full pattern set” is a set of illumination patterns that is configured in such a way to allow an image of the scene to be constructed with a resolution of M spatial points (pixels) with a sensor that has P<M physical pixels (thereby providing a resolution enhancement factor of E=M/P). A full pattern set should contain at least some linearly independent patterns of W×H resolution.

The sequence of illumination patterns should include at least one such full pattern set, i.e. a full pattern set for constructing an image of the scene that has the first resolution (where the first resolution is greater than the sensor resolution).

As will be understood by the skilled person, various such “full patterns sets” can be constructed, e.g. from the Walsh-Hadamard illumination pattern set, the Fourier illumination pattern set, variations of these (e.g. as described elsewhere herein), and so on.

In embodiments, a full pattern set that forms a complete basis for constructing an image of the scene that has the first resolution may be used. Such a full pattern set may be a complete basis set of linearly independent patterns containing exactly E patterns. However, other embodiments are possible.

For example, in various embodiments, a full pattern set may be formed from a complete basis set (as described above) plus some or all of its inverse patterns (i.e. where light areas of the pattern are replaced with dark areas, and vice versa). As will be understood by those having skill in the art, such a full pattern set can be used for so-called differential imaging, and may include 2E patterns. Differential imaging can be used, e.g. to produce images with improved contrast.

In various further embodiments, a full pattern set may be formed from some but not all (i.e. a subset) of the patterns of a complete basis set. For example a full pattern set may be formed from a subset of the patterns of a complete basis set, where the subset includes at least 5% of patterns of the complete basis set, where the subset includes at least one pattern that contains spatial frequencies fin the range W/4<f<W/2 along a first dimension W, and where the subset includes at least one pattern that contains spatial frequencies fin the range H/4<f<H/2 along a second (orthogonal) dimension H (where W/2 and H/2 are the highest frequencies possible in the pattern along corresponding dimensions according to the Nyquist theorem). As will be understood by those having skill in the art, such a full pattern set can be used for so-called compressive imaging (where the quality of the imaging is typically less than that for imaging that uses a complete basis set).

It would also be possible to combine these embodiments. For example, a compressive imaging full pattern set can be formed from a subset of the patterns of a differential imaging full pattern set. Furthermore, a full pattern set can be formed from any of the above described full patterns sets, together with one or more additional illumination patterns.

Thus, in various embodiments, the scene is illuminated with a sequence of illumination patterns that includes a full pattern set for constructing an image of the scene that has the first (high) resolution (where the first resolution is greater than the sensor resolution).

In various embodiments, the sequence of illumination patterns comprises (only) patterns from the full pattern set. The sequence of illumination patterns should include each of the patterns from a full pattern set at least once. The sequence of illumination patterns may comprise only the patterns of full pattern set (i.e. where each pattern of the full pattern set appears only once in the sequence), or one or more patterns of the full pattern set may appear more than once in the sequence of illumination patterns.

In the technology described herein, a first image of the scene that has the first (high) resolution is constructed using the detected reflections (e.g. captured images) in respect of the illumination patterns of the sequence. In order to construct the first image, detected reflections (e.g. recorded images) in respect of the illumination patterns of the sequence are combined, e.g. using appropriate computational ghost imaging (CGI) (and other related) algorithm(s).

The first image may be constructed using detected reflections (e.g. captured images) in respect of all of the illumination patterns of the sequence, or in respect of less than all of the illumination patterns of the sequence.

For example, where the sequence of illumination patterns comprises only the patterns of a full pattern set (i.e. where each pattern of the full pattern set appears only once in the sequence), then the first image may be constructed using detected reflections (e.g. captured images) in respect of all of the illumination patterns of the sequence.

Where the sequence of illumination patterns comprises more patterns than the patterns of a full pattern set (e.g. where one or more patterns of the full pattern set appear more than once in the sequence of illumination patterns), then the first image may be constructed using detected reflections (e.g. captured images) in respect of all of the illumination patterns of the sequence, or less than all of the illumination patterns of the sequence. For example, detected reflections (e.g. captured images) in respect of repeated patterns may not be used to construct the first image, and/or detected reflections (e.g. captured images) in respect of repeated patterns may be combined (e.g. averaged) before being used to construct the first image.

The resulting first (high resolution) image may be a two dimensional image, or may be a three dimensional image (e.g. where depth information is provided using a time-of-flight technique).

In the technology described herein, as well as a first (e.g. “full” or high) resolution image of the scene, a second image of the scene is also constructed that has a lower resolution than the resolution of the first image.

This is done by configuring (e.g. selecting) the sequence of illumination patterns such that it includes a (first) sub-set of illumination patterns, where the (first) sub-set of illumination patterns is configured to allow a second image of the scene having a second resolution to be constructed. A second image of the scene that has the second resolution may then be constructed using detected reflections (e.g. captured images) in respect of the first sub-set of illumination patterns.

The second resolution may comprise any suitable resolution that is less than the first resolution. The second resolution may be greater than the resolution of the detector. The second resolution may be greater than the resolution of the detector in at least one, such as in two (both), dimensions. However, it would also be possible for the second resolution to be equal to the resolution of the detector (e.g. in at least one, such as in two (both), dimensions). The second resolution may be less than the first resolution in at least one, such as in two (both), dimensions.

In various particular embodiments, the full pattern set (from which the sequence is formed) is configured (selected) such that it includes the (first) sub-set of illumination patterns (where the (first) sub-set of illumination patterns is configured to allow a second image of the scene having the second resolution to be constructed).

The first sub-set may comprise any suitable sub-set (i.e. less than all) of patterns of the sequence of illumination patterns. The sub-set should (and in various embodiments does) include a full pattern set for constructing an image of the scene that has the second resolution. The Applicant has recognised that various such lower resolution full pattern sets can be formed from sub-sets of the higher resolution full pattern set (e.g. such as from any one of the full pattern sets described herein).

In embodiments, the first sub-set includes a full pattern set that forms a complete basis for constructing an image of the scene that has the second (lower) resolution. However, in general the first sub-set may include any of the different types of full pattern set described above (e.g. including differential imaging and/or compressive imaging full pattern sets, etc.).

Thus, in various embodiments, the scene is illuminated by a sequence of illumination patterns that includes a full pattern set for constructing an image of the scene that has the first resolution, and that includes a (first) sub-set of illumination patterns that itself includes a full pattern set for constructing an image of the scene that has the second (lower) resolution. In embodiments, the full pattern set for constructing an image of the scene that has the first resolution is configured (selected) such that a sub-set of its patterns forms the full pattern set for constructing an image of the scene that has the second resolution.

The (first) sub-set of patterns may comprise (only) patterns from the second resolution full pattern set. The (first) sub-set of patterns should include each of the patterns from the second resolution full pattern set at least once. The (first) sub-set of patterns may comprise only the patterns of the second resolution full pattern set (i.e. where each pattern of the second resolution full pattern set appears only once in the (first) sub-set), or one or more patterns of the second resolution full pattern set may appear more than once in the (first) sub-set of patterns.

In the technology described herein, a second image of the scene that has the second resolution is constructed using the detected reflections (e.g. captured images) in respect of the illumination patterns of the (first) sub-set. In order to construct the second image, detected reflections (e.g. recorded images) in respect of the illumination patterns of the sub-set are combined, e.g. using appropriate computational ghost imaging (CGI) (and other related) algorithm(s).

The second image may be constructed using detected reflections (e.g. captured images) in respect of all of the illumination patterns of the (first) sub-set, or in respect of less than all of the illumination patterns of the (first) sub-set.

For example, where the (first) sub-set comprises only the patterns of a full pattern set (i.e. where each pattern of the full pattern set appears only once in the sub-set), then the second image may be constructed using detected reflections in respect of all of the illumination patterns of the (first) sub-set.

Where the (first) sub-set comprises more patterns than the patterns of a full pattern set (e.g. where one or more patterns of the full pattern set appear more than once in the (first) sub-set), then the second image may be constructed using detected reflections in respect of all of the illumination patterns of the (first) sub-set, or less than all of the illumination patterns of the (first) sub-set. For example, detected reflections (e.g. captured images) in respect of repeated patterns may not be used to construct the second image, and/or detected reflections (e.g. captured images) in respect of repeated patterns may be combined (e.g. averaged) before being used to construct the second image.

The resulting second image may be a two dimensional image, or may be a three dimensional image (e.g. where depth information is provided using a time-of-flight technique).

In various particular embodiments, the first sub-set of illumination patterns is arranged (entirely) before the end of the sequence of illumination patterns, i.e. appears in the sequence (entirely) before the end of the sequence. However, it would also be possible for the first sub-set of illumination patterns to be arranged at the end of the sequence of illumination patterns. The first sub-set of illumination patterns may be contiguous within the sequence, but this need not be the case.

The Applicant has recognised that where the first sub-set is arranged before the end of the sequence, the second image can be constructed before the scene has been illuminated with all of the patterns of the sequence (and before the first image is constructed).

Thus, in various embodiments, the second image is constructed before the scene has been illuminated with all of the patterns of the sequence. The second image may be constructed before the first image has been constructed.

This then means that the so-produced second image can be used, e.g. to control the remaining illumination patterns in the sequence of illumination patterns and/or to control a subsequent sequence of illumination patterns (and in various embodiments this is done). This in turn can provide significantly improved flexibility and control over the imaging process.

Equally, where the first sub-set of illumination patterns is arranged at the end of the sequence of illumination patterns, the second image can be used, e.g. to control a subsequent sequence of illumination patterns (and in various embodiments this is done).

Thus, in various embodiments, the second image is analysed, and (the results of the analysis are) used to control one or more remaining illumination patterns in the sequence of illumination patterns (i.e. to control one or more illumination patterns of the sequence that appear after the first sub-set) and/or to control a subsequent sequence of illumination patterns (i.e. to control one or more patterns of a second sequence of illumination patterns that is used to illuminate the scene after the sequence of illumination patterns in question). This may comprise determining whether the second image has one or more particular properties, and controlling one or more remaining patterns of the sequence based on the determination and/or controlling a subsequent sequence of illumination patterns based on the determination.

In these embodiments, the one or more particular properties can comprise any suitable property or properties of the second image. Equally, the one or more remaining patterns of the sequence and/or the subsequent sequence of illumination patterns can be controlled in any suitable manner.

In various particular embodiments, the or a property comprises the presence of a particularly bright object or objects, e.g. a reflector(s) such as a retroreflector(s), in the second image. Bright objects such as retroreflectors can significantly reduce the quality of images produced using conventional imaging techniques, e.g. by “drowning out” reflections from other objects in the scene.

In accordance with various embodiments, when a bright object is detected in the second image, the remaining patterns of the sequence and/or patterns of one or more subsequent sequences can be controlled to reduce the intensity of reflections from that object. This has the effect of increasing the overall image contrast (dynamic range) of the imaging system, e.g. by preventing certain unwanted (masked) regions from being imaged. This can be particularly beneficial when the first sub-set of illumination patterns is arranged before the end of the sequence, since for example, the image contrast (dynamic range) of the first (“full” resolution) image can be increased in an “on-the-fly” manner.

Thus, in various embodiments, it is determined whether the second image includes one or more undesired regions (e.g. one or more particularly bright regions), and one or more remaining patterns of the sequence and/or one or more subsequent sequences of illumination patterns are controlled based on the determination. The one or more remaining patterns of the sequence and/or (one or more patterns of) the one or more subsequent sequences may be controlled, e.g. so as to reduce the illumination intensity within the one or more undesired regions. In other words, the one or more undesired regions may be “masked” in one or more subsequent illumination patterns.

Where the one or more undesired regions correspond to regions of the scene that include a bright object or objects, this will increase the overall image contrast (dynamic range) of the first (“full” resolution) image.

It would also be possible for the one or more particular properties to comprise any other suitable property or properties of the second image. Equally, the one or more remaining patterns of the sequence and/or the subsequent sequence of illumination patterns can be controlled in any other suitable manner.

For example, the or a property may comprise the presence of a region of interest (in the second image), and the one or more remaining patterns of the sequence and/or (one or more patterns of) the one or more subsequent sequences may be controlled, e.g. so as to increase the illumination intensity and/or to increase the imaging resolution within the one or more regions of interest.

Other embodiments would, of course, be possible.

Thus, in general, it may be determined whether the second image includes one or more regions of interest and/or one or more undesired regions, and when it is determined that the second image includes one or more regions of interest and/or one or more undesired regions, the illumination intensity of one or more subsequent illumination patterns may be altered (e.g. increased or decreased) within the one or more regions of interest and/or one or more undesired regions, and/or the detection intensity and/or efficiency of one or more subsequent detection patterns may be altered (e.g. increased or decreased) within the one or more regions of interest and/or one or more undesired regions.

In various embodiments, in addition to the first and second images, any number of further images may be constructed.

In various particular embodiments, as well as the first (e.g. “full” or high) resolution image of the scene and the second (e.g. low) resolution image of the scene, a third image of the scene is also constructed that has a lower resolution than the resolution of the first image. Thus, various embodiments can provide low resolution images at a higher frame rate than the high resolution images.

This may be done by configuring (e.g. selecting) the sequence of illumination patterns such that it includes a second sub-set of illumination patterns, where the second sub-set of illumination patterns is configured to allow a third image of the scene having a third resolution to be constructed. A third image of the scene that has the third resolution may then be constructed using detected reflections (e.g. captured images) in respect of the second sub-set of illumination patterns.

In these embodiments, the second sub-set of illumination patterns should be formed from different illumination patterns to the illumination patterns of the first sub-set (i.e. the first and second sub-sets may be non-overlapping sub-sets).

The third resolution may comprise any suitable resolution that is less than the first resolution. The third resolution may be greater than the resolution of the detector. The third resolution may be greater than the resolution of the detector in at least one, such as in two (both), dimensions. However, it would also be possible for the third resolution to be equal to the resolution of the detector (e.g. in at least one, such as in two (both), dimensions). The third resolution may be less than the first resolution in at least one, such as in two (both), dimensions. The third resolution may be less than, equal to, or greater than the second resolution (in one or both dimensions).

The second sub-set may comprise any suitable sub-set of (i.e. less than all) patterns of the sequence of illumination patterns.

For example, the full pattern set (from which the sequence is formed) may be configured (selected) such that it includes the second sub-set of illumination patterns (in addition to the patterns of the first sub-set). Alternatively (e.g. where the full pattern set only includes a single suitable sub-set), the sequence may be configured such that the patterns of the first sub-set are repeated in the sequence (i.e. where the repeated patterns form the second sub-set).

The second sub-set may otherwise be configured in a corresponding (or otherwise) manner to the first sub-set.

Thus, the second sub-set should (and in various embodiments does) include a full pattern set for constructing an image of the scene that has the third resolution. The second sub-set may include a full pattern set that forms a complete basis for constructing an image of the scene that has the third resolution, but in general the second sub-set may include any of the different types of full pattern set described above (e.g. including differential imaging and/or compressive imaging full pattern sets, etc.).

In various embodiments, the scene is illuminated by a sequence of illumination patterns that includes a full pattern set for constructing an image of the scene that has the first resolution, that includes a first sub-set of illumination patterns that itself includes a full pattern set for constructing an image of the scene that has the second resolution, and that includes a second sub-set of illumination patterns that itself includes a full pattern set for constructing an image of the scene that has the third resolution. In embodiments, the full pattern set for constructing an image of the scene that has the first resolution is configured (selected) such that a sub-set of its patterns forms the full pattern set for constructing an image of the scene that has the second resolution, and such that a sub-set of its patterns forms the full pattern set for constructing an image of the scene that has the third resolution (where the second and third resolution sub-sets may be the same sub-set or different sub-sets).

The second sub-set of patterns may comprise (only) patterns from the third resolution full pattern set. The second sub-set of patterns should include each of the patterns from the third resolution full pattern set at least once. The second sub-set of patterns may comprise only the patterns of the third resolution full pattern set (i.e. where each pattern of the third resolution full pattern set appears only once in the second sub-set), or one or more patterns of the third resolution full pattern set may appear more than once in the second sub-set of patterns.

The third image of the scene that has the third resolution may be constructed using the detected reflections (e.g. captured images) in respect of the illumination patterns of the second sub-set, e.g. by combining detected reflections (e.g. recorded images) in respect of the illumination patterns of the second sub-set, e.g. using appropriate computational ghost imaging (CGI) (and other related) algorithm(s).

The third image may be constructed using detected reflections (e.g. captured images) in respect of all of the illumination patterns of the second sub-set, or in respect of less than all of the illumination patterns of the second sub-set.

For example, where the second sub-set comprises only the patterns of a full pattern set (i.e. where each pattern of the full pattern set appears only once in the sub-set), then the third image may be constructed using detected reflections (e.g. captured images) in respect of all of the illumination patterns of the second sub-set.

Where the second sub-set comprises more patterns than the patterns of a full pattern set (e.g. where one or more patterns of the full pattern set appear more than once in the second sub-set), then the third image may be constructed using detected reflections (e.g. captured images) in respect of all of the illumination patterns of the second sub-set, or less than all of the illumination patterns of the second sub-set. For example, detected reflections (e.g. captured images) in respect of repeated patterns may not be used to construct the third image, and/or detected reflections (e.g. captured images) in respect of repeated patterns may be combined (e.g. averaged) before being used to construct the third image.

The resulting third image may be a two dimensional image, or may be a three dimensional image (e.g. where depth information is provided using a time-of-flight technique).

The second sub-set of illumination patterns may be arranged (entirely) before the end of the sequence of illumination patterns, i.e. may appear in the sequence (entirely) before the end of the sequence. Alternatively, the second sub-set of illumination patterns may be arranged at the end of the sequence of illumination patterns. The second sub-set of illumination patterns may appear in the sequence before or after the first sub-set. The second sub-set of illumination patterns may be contiguous within the sequence, but this need not be the case.

In various embodiments, the third image is constructed before the scene has been illuminated with all of the patterns of the sequence. The third image may be constructed before the first image has been constructed. The third image may be constructed before or after the second image has been constructed (or at the same time).

The so-produced third image can be used to control (one of more of) the remaining illumination patterns in the sequence of illumination patterns and/or to control a subsequent sequence of illumination patterns, e.g. in a corresponding manner to that described above with respect to the second image.

However, in various particular embodiments, the third image may be compared to the second image, and one or more remaining patterns of the sequence of patterns may be controlled on the basis of the comparison and/or (one or more patterns of) a subsequent sequence of illumination patterns may be controlled on the basis of the comparison. This may comprise comparing the second and third images so as to determine whether the scene has one or more particular properties, and controlling one or more remaining patterns of the sequence based on the determination and/or controlling (one or more patterns of) a subsequent sequence of illumination patterns based on the determination.

In these embodiments, the one or more particular properties can comprise any suitable property or properties of the scene. Equally, the one or more remaining patterns of the sequence and/or the subsequent sequence of illumination patterns can be controlled in any suitable manner.

In various particular embodiments, the or a property comprises the presence of a moving object or objects in the scene. Moving objects can reduce the quality of images produced using conventional imaging techniques, e.g. due to undesirable motion artefacts appearing in the image.

In accordance with various embodiments, when a moving object(s) is detected in the scene, the remaining patterns of the sequence and/or patterns of one or more subsequent sequences can be controlled to reduce the intensity of reflections from that object(s). This has the effect of improving the quality of the first image, e.g. by reducing motion artefacts. This can be particularly beneficial when the first and second sub-sets of illumination patterns are arranged before the end of the sequence, since for example, the image can be improved in an “on-the-fly” manner.

Thus, in various embodiments, the second and third images are compared to determine whether the scene includes one or more moving objects, and one or more remaining patterns of the sequence and/or (one or more patterns of) one or more subsequent sequences of illumination patterns are controlled based on the determination. The one or more remaining patterns of the sequence and/or (one or more patterns of) the one or more subsequent sequences may be controlled, e.g. so as to reduce the illumination intensity within one or more regions in which the moving object(s) is present. In other words, the moving object(s) may be “masked” in one or more subsequent illumination patterns.

In addition to or instead of masking moving objects in this way, when a moving object(s) is detected in the scene, the first image and/or one or more regions of the first image may be marked as being unreliable (e.g. as containing a moving object).

Other embodiments would, of course, be possible.

As well as the first (e.g. “full” or high) resolution image of the scene, and the second and third (e.g. low) resolution images of the scene, one or more fourth images of the scene may also be constructed that each have a lower resolution than the resolution of the first image.

This may be done by configuring (e.g. selecting) the sequence of illumination patterns such that it includes one or more third sub-sets of illumination patterns, where each of the one or more third sub-sets is configured to allow one or more fourth images of the scene having one or more fourth resolutions to be constructed. One or more fourth images of the scene that have the one or more fourth resolutions may then be constructed using detected reflections (e.g. captured images) in respect of the one or more third sub-sets of illumination patterns. The one or more third sub-sets of illumination patterns should be formed from different illumination patterns to the illumination patterns of the first and second sub-sets (i.e. the first, second and one or more third sub-sets may be non-overlapping sub-sets).

The one or more fourth resolutions may each comprise any suitable resolution that is less than the first resolution. The one or more fourth resolutions may each be greater than the resolution of the detector (e.g. in at least one, such as in two (both), dimensions). However, it would also be possible for one or more or each of the one or more fourth resolutions to be equal to the resolution of the detector (e.g. in at least one, such as in two (both), dimensions). The one or more fourth resolutions may each be less than, equal to, or greater than the second and/or third resolution (in one or both dimensions).

Each of the one or more third sub-sets may comprise any suitable sub-set of (i.e. less than all) patterns of the sequence of illumination patterns. Each of the one or more third sub-sets may be configured in a corresponding manner to the first and/or second subsets, e.g. as described above.

Although various embodiments have been described above in terms of a single sequence of illumination patterns and a single first image, it will be appreciated that in embodiments the scene may be illuminated with multiple sequences of illumination patterns in turn (one by one), such that multiple first (and second etc.) images of the scene may be constructed in turn.

Although various embodiments have been described above in terms of a method and system in which a scene is illuminated using a sequence of illumination patterns, it would also or instead be possible to use so-called “single pixel imaging” techniques (and/or similar related techniques) to achieve a corresponding effect (and in embodiments, this is done).

In these embodiments, the scene may be illuminated (e.g. evenly, i.e. without the use of illumination patterns), and the reflected light may be collected (e.g. using appropriate imaging optics). A sequence of (detection) patterns may be imposed onto the reflected light, e.g. before the light is detected.

This may be achieved in any suitable manner. For example, the detection patterns may be formed on the sensor, e.g. by a spatial light modulator arranged before (e.g. in front of) the sensor. Additionally or alternatively, the sensor may be configured to have active and/or inactive regions (and/or regions with different sensitivities), which regions may form patterns.

Thus, according to a fourth aspect, there is provided a method of imaging a scene, the method comprising:
illuminating a scene; and
using a sensor to detect reflections from the scene in respect of each detection pattern of a sequence of detection patterns;
wherein the sequence of detection patterns is configured to allow a first image of the scene having a first resolution to be constructed, wherein the first resolution is greater than the resolution of the sensor;
wherein the sequence of detection patterns includes a first sub-set of detection patterns, wherein the first sub-set of detection patterns is configured to allow a second image of the scene having a second resolution to be constructed, and wherein the second resolution is less than the first resolution; and
wherein the method further comprises:
using detected reflections in respect of the detection patterns of the sequence to construct a first image of the scene having the first resolution; and
using detected reflections in respect of the first sub-set of detection patterns to construct a second image of the scene having the second resolution.

According to a fifth aspect, there is provided an imaging system comprising:
one or more sources configured to illuminate a scene; and
a sensor configured to detect reflections from the scene in respect of each detection pattern of a sequence of detection patterns;
wherein the sequence of detection patterns is configured to allow a first image of the scene having a first resolution to be constructed, wherein the first resolution is greater than the resolution of the sensor;
wherein the sequence of detection patterns includes a first sub-set of detection patterns, wherein the first sub-set of detection patterns is configured to allow a second image of the scene having a second resolution to be constructed, and wherein the second resolution is less than the first resolution; and
wherein the system further comprises a processing circuit configured to:
use detected reflections in respect of the detection patterns of the sequence to construct a first image of the scene having the first resolution; and
use detected reflections in respect of the first sub-set of detection patterns to construct a second image of the scene having the second resolution.

According to a sixth aspect, there is provided an image processing system comprising:
a processing circuit configured to control the system such that reflections from a scene are detected using a sequence of detection patterns; and
a processing circuit configured to receive information from a sensor that is configured to detect reflections from the scene in respect of each detection pattern of the sequence;
wherein the sequence of detection patterns is configured to allow a first image of the scene having a first resolution to be constructed, wherein the first resolution is greater than the resolution of the sensor;
wherein the sequence of detection patterns includes a first sub-set of detection patterns, wherein the first sub-set of detection patterns is configured to allow a second image of the scene having a second resolution to be constructed, and wherein the second resolution is less than the first resolution; and
wherein the system further comprises a processing circuit configured to:
use detected reflections in respect of the detection patterns of the sequence to construct a first image of the scene having the first resolution; and
use detected reflections in respect of the first sub-set of detection patterns to construct a second image of the scene having the second resolution.

As will be appreciated by those skilled in the art, these aspects can and in embodiments do include any one or more or all of the optional features of the technology described herein, e.g. where illumination patterns are replaced with detection patterns as appropriate, mutatis mutandi.

Thus, for example, in these embodiments, a detection pattern may be an illumination intensity distribution on the sensor, and/or a detection efficiency distribution of the sensor. A detection pattern may be binary, multi-level, or continuous (e.g. as described above mutatis mutandi). Each detection pattern may, in effect, be a two dimensional illumination intensity distribution pattern and/or detection efficiency distribution pattern (i.e. a two dimensional detection distribution pattern), e.g. may be capable of being described by a two dimensional pattern (e.g. as described above mutatis mutandi). Each pattern in the sequence may be different from each other pattern in the sequence, i.e. in terms of the illumination intensity distribution on the sensor and/or the detection efficiency distribution of the sensor.

The sequence of detection patterns may include a full pattern set for constructing an image of the scene having the first resolution, and/or the first sub-set of detection patterns may include a full pattern set for constructing an image of the scene having the second resolution (e.g. as described above mutatis mutandi).

The first sub-set of detection patterns may be arranged (entirely) before the end of the sequence of detection patterns, i.e. may appear in the sequence (entirely) before the end of the sequence. The second image may be constructed before reflections have been detected using all of the detection patterns of the sequence of detection patterns (e.g. as described above mutatis mutandi).

In these embodiments, it may be determined whether the second image has one or more properties, and one or more subsequent detection patterns may be controlled on the basis of the determination, e.g. where controlling one or more subsequent detection patterns on the basis of the determination may comprise controlling one or more remaining patterns of the sequence of detection patterns on the basis of the determination and/or controlling one or more detection patterns of a subsequent sequence of detection patterns on the basis of the determination (e.g. as described above mutatis mutandi).

In these embodiments, it may be determined whether the second image includes one or more regions of interest and/or one or more undesired regions such as one or more bright regions, and when it is determined that the second image includes one or more regions of interest and/or one or more undesired regions, a detection intensity (e.g. an illumination intensity distribution on the sensor, and/or a detection efficiency distribution of the sensor) may be altered (e.g. reduced) of one or more subsequent detection patterns within the one or more undesired regions. This may be done, e.g. by altering (e.g. reducing) the transmission of light through a corresponding region of a spatial light modulator and/or by altering (e.g. reducing) the sensitivity of a corresponding region of the sensor.

In these embodiments, the sequence of detection patterns may include a second (or third, fourth, etc.) sub-set of detection patterns (e.g. which may or may not be arranged before the end of the sequence), wherein the second sub-set of detection patterns may be configured to allow a third (or fourth, fifth, etc.) image of the scene having a third resolution to be constructed, where the third resolution may be greater than the resolution of the sensor, and where the third resolution may be less than the first resolution (e.g. as described above mutatis mutandi).

In these embodiments, detected reflections in respect of the second sub-set of detection patterns may be used to construct a third image of the scene having the third resolution (e.g. where the third image may optionally be constructed before reflections have been detected using all of the detection patterns of the sequence of detection patterns). The third image may be compared to the second image, and one or more subsequent detection patterns may be controlled on the basis of the comparison, and/or it may be determined whether the scene includes a moving object on the basis of the comparison (e.g. as described above mutatis mutandi).

It would also be possible to combine the methods that use a sequence of illumination patterns with the methods that use a sequence of detection patterns. For example, the light may be spatially modulated both in the illumination system and in the detector system.

Thus, according to a seventh aspect, there is provided a method of imaging a scene, the method comprising:
illuminating a scene; and
using a sensor to detect reflections from the scene in respect of each pattern of a sequence of patterns;
wherein the sequence of patterns is configured to allow a first image of the scene having a first resolution to be constructed, wherein the first resolution is greater than the resolution of the sensor;
wherein the sequence of patterns includes a first sub-set of patterns, wherein the first sub-set of patterns is configured to allow a second image of the scene having a second resolution to be constructed, and wherein the second resolution is less than the first resolution; and
wherein the method further comprises:
using detected reflections in respect of the patterns of the sequence to construct a first image of the scene having the first resolution; and
using detected reflections in respect of the first sub-set of patterns to construct a second image of the scene having the second resolution.

According to an eighth aspect, there is provided an imaging system comprising:
one or more sources configured to illuminate a scene; and
a sensor configured to detect reflections from the scene in respect of each pattern of a sequence of patterns;
wherein the sequence of patterns is configured to allow a first image of the scene having a first resolution to be constructed, wherein the first resolution is greater than the resolution of the sensor;
wherein the sequence of patterns includes a first sub-set of patterns, wherein the first sub-set of patterns is configured to allow a second image of the scene having a second resolution to be constructed, and wherein the second resolution is less than the first resolution; and
wherein the system further comprises a processing circuit configured to:
use detected reflections in respect of the patterns of the sequence to construct a first image of the scene having the first resolution; and
use detected reflections in respect of the first sub-set of patterns to construct a second image of the scene having the second resolution.

According to a ninth aspect, there is provided an image processing system comprising:
a processing circuit configured to control the system such that reflections from a scene are detected in respect of a sequence of patterns; and
a processing circuit configured to receive information from a sensor that is configured to detect reflections from the scene in respect of each pattern of the sequence;
wherein the sequence of patterns is configured to allow a first image of the scene having a first resolution to be constructed, wherein the first resolution is greater than the resolution of the sensor;
wherein the sequence of patterns includes a first sub-set of patterns, wherein the first sub-set of patterns is configured to allow a second image of the scene having a second resolution to be constructed, and wherein the second resolution is less than the first resolution; and
wherein the system further comprises a processing circuit configured to:
use detected reflections in respect of the patterns of the sequence to construct a first image of the scene having the first resolution; and
use detected reflections in respect of the first sub-set of patterns to construct a second image of the scene having the second resolution.

The sequence of patterns may be a sequence of illumination patterns and/or a sequence of detection patterns. The scene may be illuminated using a sequence of illumination patterns, and the sensor may be used to detect reflections from the scene in respect of each illumination pattern of the sequence, and/or the sensor may be used to detect reflections from the scene in respect of each detection pattern of a sequence of detection patterns.

As will be appreciated by those skilled in the art, these aspects can and in embodiments do include any one or more or all of the optional features of the technology described herein.

As will be appreciated by those skilled in the art, all of the aspects and embodiments of the technology described herein can and may include any one or more or all of the optional features described herein, as appropriate.

The methods in accordance with the technology described herein may be implemented at least partially using software e.g. computer programs. It will thus be seen that when viewed from further aspects there is provided computer software specifically adapted to carry out the methods herein described when installed on a data processor, a computer program element comprising computer software code portions for performing the methods herein described when the program element is run on a data processor, and a computer program comprising code adapted to perform all the steps of a method or of the methods herein described when the program is run on a data processing system. The data processing system may be a microprocessor, a programmable FPGA (Field Programmable Gate Array), etc.

The technology described herein also extends to a computer software carrier comprising such software which when used to operate an imaging system comprising a data processor causes in conjunction with said data processor said system to carry out the steps of the methods described herein. Such a computer software carrier could be a physical storage medium such as a ROM chip, CD ROM or disk, or could be a signal such as an electronic signal over wires, an optical signal or a radio signal such as to a satellite or the like.

It will further be appreciated that not all steps of the methods described herein need be carried out by computer software and thus from a further broad aspect the technology described herein provides computer software and such software installed on a computer software carrier for carrying out at least one of the steps of the methods set out herein.

The technology described herein may accordingly suitably be embodied as a computer program product for use with a computer system. Such an implementation may comprise a series of computer readable instructions either fixed on a tangible medium, such as a non-transitory computer readable medium, for example, diskette, CD ROM, ROM, or hard disk. It could also comprise a series of computer readable instructions transmittable to a computer system, via a modem or other interface device, over either a tangible medium, including but not limited to optical or analogue communications lines, or intangibly using wireless techniques, including but not limited to microwave, infrared or other transmission techniques. The series of computer readable instructions embodies all or part of the functionality previously described herein.

Those skilled in the art will appreciate that such computer readable instructions can be written in a number of programming languages for use with many computer architectures or operating systems. Further, such instructions may be stored using any memory technology, present or future, including but not limited to, semiconductor, magnetic, or optical, or transmitted using any communications technology, present or future, including but not limited to optical, infrared, or microwave. It is contemplated that such a computer program product may be distributed as a removable medium with accompanying printed or electronic documentation, for example, shrink wrapped software, pre-loaded with a computer system, for example, on a system ROM or fixed disk, or distributed from a server or electronic bulletin board over a network, for example, the Internet or World Wide Web.

A number of embodiments of the technology described herein will now be described by way of example only and with reference to the accompanying drawings, in which:

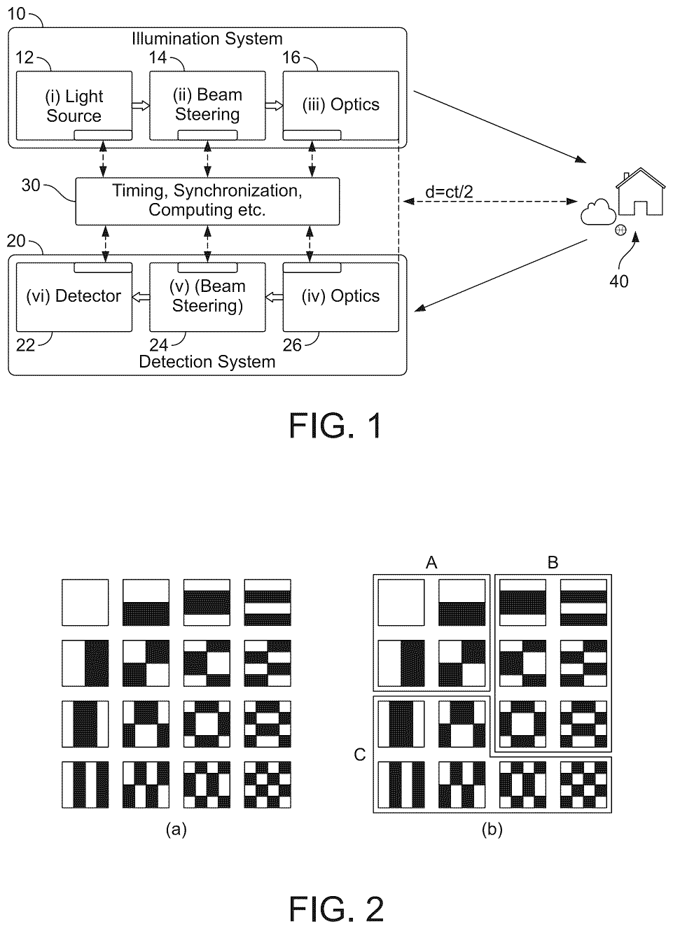

FIG. 1 shows schematically an imaging system in accordance with various embodiments;

FIG. 2(a) shows the Walsh-Hadamard illumination pattern set for imaging with 4×4 pixel resolution, and FIG. 2(b) shows the division of the Walsh-Hadamard illumination pattern set into subsets for multi-resolution imaging in accordance with various embodiments;

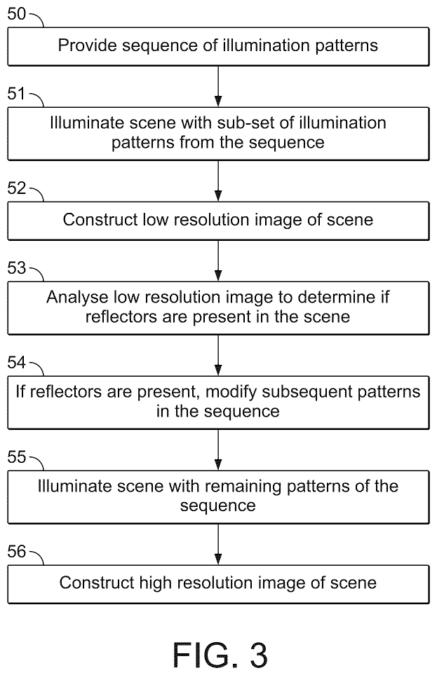

FIG. 3 is a flow diagram illustrating a method according to various embodiments;

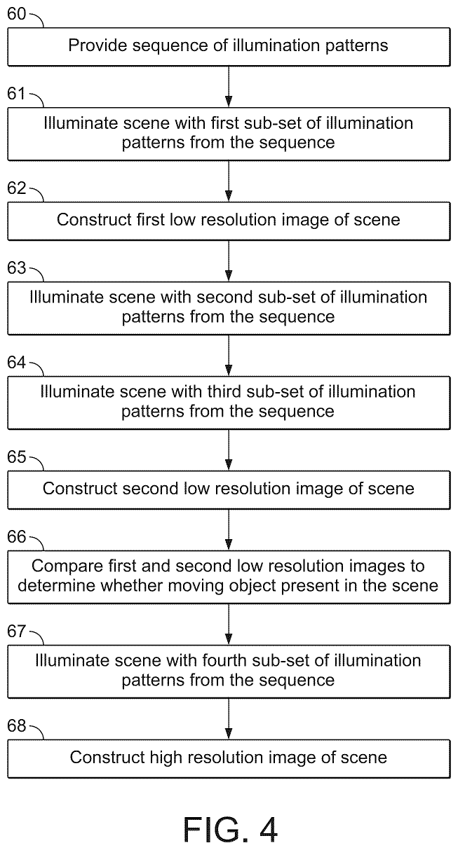

FIG. 4 is a flow diagram illustrating a method according to various embodiments;

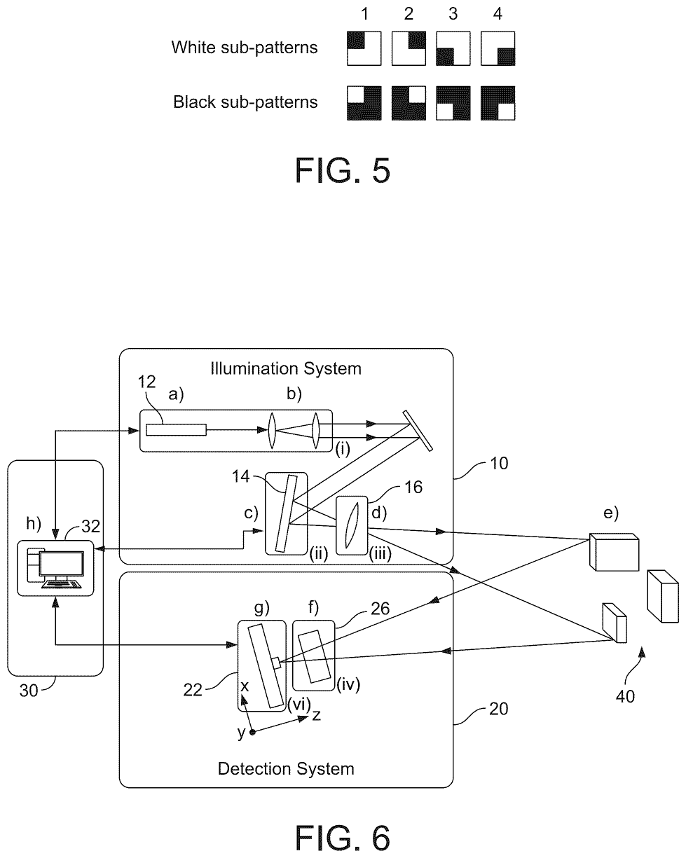

FIG. 5 shows example sub-patterns that can be used to modify the Walsh-Hadamard illumination pattern set of FIG. 2 for multi-resolution imaging in accordance with various embodiments;

FIG. 6 shows schematically an imaging system in accordance with various embodiments; and

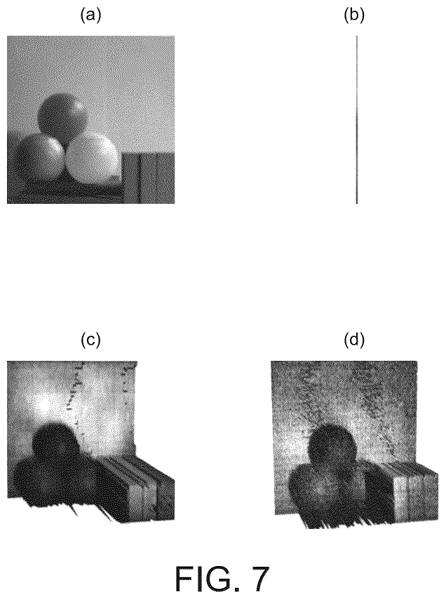

FIG. 7(a) shows a photographic image of a scene, FIG. 7(b) shows a raw line sensor image of the scene, FIG. 7(c) shows a reconstructed 64×64 pixel resolution 3D image of the scene, and FIG. 7(d) shows a reconstructed 128×128 pixel resolution 3D image of the scene.

Like reference numerals are used for like components where appropriate in the Figures.

Various embodiments relate generally to methods of 2D and 3D imaging, image reconstruction algorithms, and imaging systems, such as for example methods of LiDAR (Light Detection and Ranging) imaging and LiDAR imaging systems.

Known imaging systems such as LiDAR (light detection and ranging) imaging systems have several limitations. For example, commercially available mid- and long range (50-200 m) scanning automotive LiDAR systems include macroscopic mechanical parts that are constantly moving and prone to damage. Such devices are expensive and have cumbersome designs. While dynamic and adaptive control over the output parameters is sometimes possible, it is challenging to achieve and requires compromising other parameters. In addition, it is difficult to correlate the output of such systems (i.e. point clouds) with 2D images from conventional photographic cameras, meaning that existing image recognition algorithms developed for 2D images are challenging to use in conjunction with scanning LiDARs.

Alternatives to scanning LiDARs, such as time-of-flight (ToF) 3D cameras (e.g. single photon avalanche diode (SPAD) cameras), are emerging. While these systems can solve in part the problems with conventional scanning LiDARs (especially bulkiness and the usage of macroscopic moving parts), current systems commonly have an image resolution (number of pixels) that is insufficient for use in vehicles for autonomous navigation. More advanced high-resolution systems based on known designs are relatively complex and expensive to implement.

Various embodiments are directed to a method of operating an active camera such as a LiDAR system. In particular, embodiments are directed to simultaneous multi-frame-rate and multi-resolution operation of an active camera using encoded illumination.

The active imaging camera contains a controllable light source, which is configured to selectively illuminate parts of the imaged scene within its field of view, and a light detector (which can comprise multiple individual light detectors or pixels) which is configured to detect light reflected and scattered by the objects in the scene. The active camera can be a 2D camera, or a 3D camera e.g. where the depth information is provided using a time-of-flight technique.

As is described in more detail elsewhere herein, in accordance with various embodiments, dynamically controlled encoded illumination is used to allow the active camera to obtain images with a resolution higher than the native resolution of the detector (where the output image contains more pixels than the detector), and to simultaneously provide images with different resolutions optionally at different frame rates. Dynamically controlled encoded illumination may also be used to detect which parts of the image contain moving objects or unreliable data, to provide a high-resolution image of a dynamically allocated region of interest (which may be a subset of the whole field of view), and/or to increase the overall image contrast (dynamic range) e.g. by preventing certain unwanted (masked) regions from being imaged.

FIG. 1 illustrates a LiDAR system that may be operated in accordance with various embodiments.

A LiDAR system is an active sensor that illuminates a scene and detects the flight time of light directly or indirectly. Thus, as shown in FIG. 1, a LiDAR system generally comprises an illumination system 10, a detection system 20, and one or more processing circuits 30.

The illumination system 10 is configured to illuminate a scene 40 with electromagnetic radiation such as light. To do this, the illumination system may generally comprise, inter alia, a light source 12, optional beam steering component(s) 14, and optics 16.

The detection system 20 is configured to detect reflections from the scene 40 of the electromagnetic radiation (light) from the illumination system 10. To do this, the detection system 20 may generally comprise, inter alia, a detector 22, optional beam steering component(s) 24, and optics 26.

The processing circuit(s) 30 is configured to control the illumination system 10 and the detection system 20, e.g. to control their timing and synchronisation (e.g. ensure that the illumination system 10 and the detection system 20 are appropriately synchronised), and so on. The processing circuit(s) 30 can also process images captured by the detector 22 so as to construct 3D images of the scene 40.

The LiDAR system may be configured to use a direct time of flight depth determination technique, e.g. where short (e.g. nanosecond or picosecond duration) light pulses are used for illumination, and the detector 22 is configured with a matching temporal resolution. The system may be configured to measure the time light has taken to travel from the light source 12 to the scene 40 and back to the detector 22, and the system can therefore infer the distance d to objects within the scene 40 that reflected the light.

Alternatively, the LiDAR system may be configured to use an indirect time of flight depth determination technique, e.g. where modulated continuous wave electromagnetic radiation is used for illumination, and the detector 22 is configured to detect the phase difference in the modulation of transmitted and received signals. The modulation may be applied, for example, to the amplitude and/or to the frequency (wavelength) of the radiation. The system may be configured to measure the change in the phase of modulation that occurred during the time the light has taken to travel from the light source 12 to the scene 40 and back to the detector 22, and the system can therefore infer the distance to objects within the scene 40 that reflected the light.

In these embodiments, the system may be configured to use encoded light to illuminate the scene 40 of interest.

The detector 22 may comprise, for example, a single-photon sensitive solid-state detector array, such as a single photon avalanche diode (SPAD) array, or a Geiger mode avalanche photodiode (GmAPD) array. Such a detector 22 may be configured to provide sub-nanosecond temporal resolution, thereby enabling direct time of flight measurements. Sub-nanosecond resolution is advantageous because the temporal resolution directly translates to depth resolution of the sensor (e.g. 100 ps temporal resolution equates to 1.5 cm depth resolution).

In combination with a laser that provides short enough pulses, SPAD-based detectors (including SPAD arrays) are particularly beneficial for LiDAR systems. However, the pixel count and hence the lateral resolution of SPAD arrays can be relatively low compared to conventional 2D cameras.

In accordance with various embodiments, a technique known as computational ghost imaging (CGI) may therefore be used to achieve a higher effective image resolution than the native resolution of the sensor 22.

CGI can be used to acquire 2D images of objects by illuminating the scene with different light patterns (using, e.g., a digital light projector), and measuring the total reflected light intensity for each light pattern with a single pixel sensor. CGI can also be used to increase the effective resolution of multipixel sensors and for 3D imaging with single pixel or multipixel sensors.

In accordance with various other embodiments, a similar technique known as single pixel imaging (or single pixel camera) can be used to achieve the same goals (2D imaging with a single pixel sensor, resolution enhancement of multipixel sensors, and 3D imaging). The main difference is that in case of single pixel imaging, the object is illuminated uniformly and the reflected light is spatially encoded with spatial patterns on the detector side of the system.

In these embodiments, the scene 40 is illuminated, and reflected light is collected with imaging optics 26. Light patterns (detection patterns) are imposed onto the reflected light in the detection system 20. The scene may be illuminated evenly, and the patterns can be formed on the detector 22 by the optics using the light reflected from the scene 40, for example by means of a spatial light modulator placed in front of the detector 22. Additionally or alternatively, the detector 22 can have active and inactive areas (or broadly speaking, areas with different sensitivities), that form a pattern or patterns. In this case, the detector 22 may be illuminated evenly by the light reflected from the scene.

Furthermore, a combination of these methods may be used, e.g. where the light is actively spatially modulated both in the illumination system 10 and the detector system 20.

Thus, embodiments comprise illuminating the scene 40 with different light patterns and recording the detector 22 signal values for each pattern, and/or illuminating the scene 40 evenly and recording the detector 22 signal values for different detection patterns. This enables the effective resolution of the combined image to be higher than the native resolution of the detector 22.

An “illumination pattern” or “light pattern” defines the illumination intensity distribution within the field of view of the imaging system on a given measurement step (during a single detector 22 exposure time period). A “full pattern set” is a set of illumination patterns that is sufficient to reconstruct an image (such as a 3D-image) of the scene 40 with the resolution of M spatial points (pixels) with a sensor 22 that has P<M physical pixels.

Light patterns can be either 1) binary, having two different illumination levels (e.g., illuminated and non-illuminated areas); 2) multi-level, containing a discrete number of different illumination levels; or 3) continuous, where the illumination intensity smoothly changes between the areas of the field of view.

The illumination distribution of a light pattern may be defined e.g., on a discrete grid (e.g., Cartesian or polar); in a discrete number of spatial points that may or may not be distributed regularly in the field of view; or as a mathematical function of non-discrete spatial coordinates in the field of view.

Thus, embodiments comprise pattern-based illumination, i.e. the light source 12 is configured to project a sequence of patterns, i.e. where each pattern has a predefined intensity distribution. To reconstruct an image at resolution higher than native detector resolution, a set of patterns is projected onto the scene in sequence. An output image is then reconstructed using single pixel imaging algorithms, ghost imaging algorithms, or their derivatives.

As an example, consider a single pixel detector, where a final 2D image resolution is desired to be 4×4 pixels (the total number of image pixels is in this case is N=4×4=16).

Light patterns based on the Walsh-Hadamard basis set may be used in this case. The full Walsh-Hadamard pattern set for N=16 is shown in FIG. 2(a) (i.e. the Walsh-Hadamard light pattern set for imaging with 4×4 pixel resolution). In FIG. 2, white represents illuminated areas and black represents dark areas.

As can be seen from FIG. 2(a), the number of patterns is equal to the number of final image pixels. Therefore, N measurements are made, yielding N detector signals.

The image reconstruction is mathematically equivalent to solving a fully determined nonhomogeneous system of linear equations with N equations and N unknowns (i.e., the image pixel values). The equation coefficients are determined by the light patterns and the right-hand side vector contains the measured signals.

In this form of CGI, there is a trade-off between image resolution and measurement time: increasing the image resolution linearly increases the number of light patterns and hence the measurement time.

In CGI for time-of-flight 3D imaging, while the scene is still illuminated with different (spatial) light patterns, a pulsed laser is used as the light source and the reflected light is collected with a fast photodetector. The main difference with 2D imaging is that each detector signal is now a time series, where the location on the time axis directly corresponds to the object distance from the imaging device.

However, the CGI method can still be applied for image reconstruction as follows. The temporal axis is divided into discrete time bins. Within a single time bin, the detector signals corresponding to different light patterns contain all the information about a slice of the 3D image and the CGI reconstruction method can be applied to each slice separately. Each slice may correspond to the same time period (i.e. the same bin), but this need not be the case. For example, slices can be defined that are formed by different bins for different detector pixels.

In the case of increasing the effective resolution of a multipixel sensor, each physical sensor pixel can be considered separately with its own field of view, and N becomes the resolution enhancement factor (i.e., it shows how much the effective resolution is higher than the native resolution of the sensor). For example, if the native resolution of the sensor is 100×100 pixels and the desired resolution enhancement factor is 4×4, a total of 16 different light patterns should be displayed to obtain a 400×400 pixel image.

Again, there is a trade-off between the resolution enhancement factor and the measurement time. For applications such as automotive LiDARS, there is a minimum requirement for the frame rate (typically around 20-30 Hz), which sets a practical upper limit to the resolution enhancement factor. Moreover, if there are moving objects in the scene that have significantly changed position during the measurement of the full light pattern set, there can be motion artefacts in the final reconstructed 2D or 3D image.

Embodiments provide methods to alleviate the shortcomings of the existing techniques. Embodiments allow simultaneous acquisition of high frame rate low resolution images and low frame rate high resolution images. Moreover, by analysing the changes in the low-resolution images, it can be predicted if different areas of the high-resolution images contain motion artefacts or low signal-to-noise ratio. Embodiments can be used both for 2D and 3D imaging, however embodiments are for 3D imaging.

In embodiments, the sequence of light patterns and the signal post-processing are configured to enable multiple resolutions and frame rates at the same time.

In particular, at least one subset of the full pattern set can be used to reconstruct the image at lower resolution than the full set allows, but still higher than the native detector resolution. A full pattern set may contain multiple such subsets.

Individual patterns that form a subset of a full pattern set are projected in sequence such that a low-resolution image can be reconstructed before all the patterns from the full set are projected. Such a subset (the same or a different one) can be projected multiple times until the full set is projected.

Embodiments can also utilise adaptive pattern generation (e.g. masking), where patterns may be altered on frame-by frame basis, e.g. by introducing fully black areas into all of the patterns. Adaptive pattern generation (specifically, the ability to mask parts of the pattern) allows bright objects to be excluded (either close-by bright objects or objects with very high reflectivity) from the scene, so as to improve image contrast (dynamic range). The information on the location of such objects is still available in the first low-resolution image.

Thus, embodiments comprise the use of specifically designed patterns, a specific ordering of patterns, and adaptive pattern generation (e.g. masking). Together, these features may be referred to as “dynamically controlled encoded illumination”.

Compared to conventional scanning LiDAR, dynamically controlled encoded illumination allows image resolution to be converted into a dynamically controllable parameter, and output images to be produced at multiple resolutions at the same time. Compared to conventional flash LiDAR, the imaging resolution is not limited by the native photodetector resolution, which at the current state of development is much lower than for 2D cameras and is often insufficient for full autonomous navigation. Compared to conventional ghost/single pixel imaging techniques, embodiments can simultaneously output multiple images at different resolutions (all higher that native detector resolution), detect fast motion that happens within one frame, and can label motion artefacts in the output image.

Using a relatively cheap photodetector that may have suboptimal resolution for autonomous navigation, dynamically controlled encoded illumination allows a 3D camera system to be created which can control the resolution dynamically as a parameter, simultaneously output multiple images at optimal resolution and frame rate combinations, and enable high-contrast imaging even in the presence of bright objects (such as retro-reflectors).

FIG. 3 illustrates a multi-resolution imaging technique in accordance with various embodiments.

As shown in FIG. 3, an initial sequence of illumination patterns is provided, where the initial sequence of illumination patterns forms a full pattern set for constructing an image of the scene having a “full” or “high” resolution (step 50). The scene 40 is illuminated with a sub-set of illumination patterns from the sequence, where the sub-set forms a full pattern set for constructing an image of the scene having a low resolution (step 51), and a low resolution image of the scene is then constructed (step 52).

Next, the low resolution image is analysed to determine whether a reflector is present in the scene (step 53). If a reflector is present, the remaining patterns in the sequence are modified, i.e. so as to reduce reflection from the reflector (step 54).

The scene is then illuminated with the remaining (modified) patterns of the sequence (step 55), and a full, high resolution image of the scene is constructed (step 56).

This sequence may then be repeated, so as to produce one or more further high resolution images, etc.

FIG. 4 illustrates another embodiment. As shown in FIG. 4, an initial sequence of illumination patterns may be provided, where the sequence of illumination patterns forms a full pattern set for constructing an image of the scene having a “full” or “high” resolution (step 60). The scene 40 is illuminated with a first sub-set of illumination patterns from the sequence, where the sub-set forms a full pattern set for constructing an image of the scene having a low resolution (step 61), and a first low resolution image of the scene is then constructed (step 62).

The scene may then be illuminated with a second sub-set of illumination patterns from the sequence (step 63), followed by a third sub-set of illumination patterns from the sequence (step 64). The third sub-set may again form a full pattern set for constructing an image of the scene having a low resolution, and a second low resolution image of the scene may be constructed (step 65). The third sub-set may include the same illumination patterns as the first sub-set or otherwise.

Next, the first and second low resolution images are compared to determine whether or not one or more moving objects are present in the scene (step 66).

The scene is then illuminated with the remaining patterns of the sequence (step 67), and a full, high resolution image of the scene is constructed (step 68). If, at step 66, it is determined that the scene includes a moving object, the high resolution image of the scene may be marked as including a moving object and/or as being unreliable.

This sequence may then be repeated, so as to produce one or more further high resolution images, etc.

Returning to the example of FIG. 2, consider an arrangement in which a 4×4 pixel image is a “high” resolution image, and a 2×2 pixel image is a “low” resolution image. As a property of the Walsh-Hadamard pattern set, the light patterns needed to reconstruct a low-resolution image of an object form a subset of the high-resolution patterns.

FIG. 2(b) illustrates the division of the Walsh-Hadamard pattern set into subsets for multi-framerate multi-resolution imaging. As shown in FIG. 2(b), subset A forms a complete basis for imaging with 2×2 pixel resolution, and can be used independently of the full set to acquire a low-resolution image.

Thus, by displaying patterns of subset A before the end of the sequence, a low resolution image can be constructed before all of the patterns in the full sequence have been displayed (and before the full resolution image is constructed).

In various further embodiments, the following pattern sequence can be used in the measurements: (i) subset A (immediately yielding a low resolution image); followed by (ii) subset B; followed by (iii) subset A (yielding an independent low resolution image); followed by (iv) subset C (together with previous subsets yielding a high-resolution image).

Thus, subset A may be repeated two times before the end of the sequence, thereby allowing two low resolution images to be constructed before all of the patterns in the full sequence have been displayed (and before the full resolution image is constructed). It should be noted that by displaying subset A for the second time, the total measurement time is increased by 25% in this example (if the pattern display time is held constant).

In this embodiment, each low-resolution image can be reconstructed in the manner described above in respect of conventional CGI techniques, using the data from a single measurement step (e.g. step (i) or (iii)).

To reconstruct the high-resolution image, the data from the full measurement sequence is used. This may be done by using the signals from a single measurement step (step (i) or (iii)), or by averaging the signals from each measurement pair in steps (i) and (iii), that use the same illumination pattern. In this case, the effective number of measurements is reduced to N, and again conventional CGI techniques can be used for the reconstruction.

If the measurement steps (i) and (iii), give similar results (determined, e.g., via cross-correlation), then there is a high probability that the scene has remained static during the measurement sequence and no motion artefacts are present in the high-resolution image. Conversely, differences in the low-resolution images can indicate possible movement in the scene. These parts of the high-resolution image may be discarded or labelled as unreliable in the output to the user. Note that in 3D imaging, the difference between the low-resolution images may also be in the depth dimension (caused, e.g., by an object moving towards the imaging system).

Although specific examples have been described above, a number of embodiments are possible. Various variants and generalizations of the method are possible.

For example, in various embodiments, a basis set other than the Walsh-Hadamard set can be used to construct the light patterns. For example, the Fourier basis also has the necessary properties for the multi-framerate multi-resolution imaging.

In embodiments, the high and low resolutions can be any powers of 2 for the Walsh-Hadamard pattern set, and the horizontal and vertical resolutions do not need to be the same. For example, the low resolution can be 1×4 pixels and the corresponding high resolution can be 16×32 pixels. With the Fourier basis set the constraints are even looser: any integer resolution is possible if the high resolution is divisible by the low resolution in both lateral axes.

In embodiments, the division of patterns between subsets B and C can be different to that shown in FIG. 2(b). The best results may be obtained when B and C contain an equal number of patterns, however this may not be necessary.

In various embodiments, pattern sequences may be constructed where a low-resolution image is acquired more than twice during the full sequence.

For example, referring again to FIG. 4, a pattern sequence may be constructed such that the second sub-set of illumination patterns (step 63) forms a full pattern set for constructing an image of the scene having a low resolution, and an additional low resolution image of the scene may be constructed using detected reflections in respect of the second sub-set of patterns. Additionally or alternatively, a pattern sequence may be constructed such that the fourth sub-set of illumination patterns (step 67) forms a full pattern set for constructing an image of the scene having a low resolution, and an additional low resolution image of the scene may be constructed using detected reflections in respect of the fourth sub-set of patterns.

Although in FIG. 4, the low resolution images produced using the first and third sub-sets of illumination patterns are compared, in embodiments, the low resolution images that are compared to determine whether a moving object is present in the scene can be low resolution images produced using any two (or more) of the various sub-sets of illumination patterns (e.g. from any two of the first 61, second 63, third 64 and fourth 67 sub-sets in FIG. 4).

In various embodiments, pattern sequences may be constructed where instead of two simultaneously acquired resolutions there are three or more.

In various embodiments, the methods can be used with single pixel, 1D (linear) or 2D (matrix) sensors.

In embodiments, the different light patterns can be produced using a scanning laser system. For example, a narrow pulsed laser beam (e.g. 100 ps-wide pulses at 1 MHz) may be steered in such a way that it illuminates different spots of the scene with different individual pulses (which may be called scanning), but where during the whole sensor exposure time (e.g. 1 ms), the signal accumulated by the sensor is equivalent to the one obtained from a pattern drawn spot by spot by the laser.

However, due to the nature of scanning the scene with a relatively narrow laser beam, the low resolution images may contain gaps between the scanning trajectories, and small objects may be missed. Thus, embodiments use encoded flood illumination, such that the information about such small objects can be retained even in low resolution images.

In various further embodiments, holographically generated projections can be used to create the patterns.

In embodiments, in the case of a multipixel detector, the signals from several physical sensor pixels may be added up in the reconstruction of the low-resolution image. This may be advantageous, e.g., in low light conditions, where the relative measurement noise can be high.

In embodiments, a technique known as differential imaging can be used. In differential imaging, each light pattern is followed by its inverse (where illuminated areas are replaced with dark areas and vice versa). As a result, 2N patterns are needed in differential imaging to reconstruct an N-pixel image with a single pixel detector.

In embodiments, strongly reflecting objects (such as retroreflectors) may saturate the sensor signal and hence decrease the reconstruction accuracy. An adaptive imaging algorithm may be used, where the location of such reflectors is identified from the previous frame, and special light patterns are constructed, where parts of the field of view including the reflectors are illuminated with less intensity (or not illuminated at all). This enables an increase in the dynamic range of the system.

In various embodiments, pattern sequences can be constructed where individual patterns are linear combinations of patterns, e.g. from subset A of FIG. 2(b) and other subsets. An example of such pattern set can be obtained, e.g. from subset A of FIG. 2(b) if it was repeated 4 times, where: in the first repetition each white 2×2-pixel square is replaced with a top sub-pattern from the first column of FIG. 5 and each black 2×2-pixel square is replaced with a bottom sub-pattern from the first column of FIG. 5; in the second repetition, each white 2×2-pixel square is replaced with a top sub-pattern from the second column of FIG. 5 and each black 2×2-pixel square is replaced with a bottom sub-pattern from the second column of FIG. 5, and so on.

Such a pattern set allows a low-resolution image to be obtained four times during the full sequence without an increase in total measurement time. There is, however, a drawback in terms of a decrease in the contrast of the low-resolution images.

In general the sub-patterns may be constructed using different methods as long as the following criteria are met: 1) the sub-patterns should be unbalanced, i.e., the illuminated and dark areas should be unequal in total area; and 2) the white sub-patterns should form a full pattern set for a resolution equal to the ratio of resolutions of the high resolution and low resolution images (along both dimensions), likewise the black sub-patterns should also form a full pattern set for a resolution equal to the ratio of resolutions of the high resolution and low resolution images (along both dimensions).

As described above, illuminating the scene with different light patterns and recording the detector signal values for each pattern enables the effective resolution of the combined image to be higher than the native resolution of the detector. The combined image may have W×H resolution, and W*H=M total pixels, and the detector may have P<M physical pixels.

A full pattern set is a set of illumination patterns that is sufficient to reconstruct an image of the scene with the resolution of M spatial points (pixels) using a detector that has P physical pixels. A resolution enhancement factor is defined as E=M/P. A full pattern set should contain at least some linearly independent patterns of W×H resolution.

A full pattern set can, for example, be one of the following types:
Type (1): A complete basis set of linearly independent patterns containing exactly E patterns.
Type (2): A set containing the type (1) patterns and all its inverse patterns (used for differential imaging), 2E patterns in total.
Type (3): A subset of the type (1) patterns containing at least 5% of the type (1) patterns, such that at least one pattern from the subset contains spatial frequencies fin the range W/4<f<W/2 along dimension W, and at least one pattern contains spatial frequencies fin the range H/4<f<H/2 along dimension H, where W/2 and H/2 are the highest frequencies possible in the pattern along corresponding dimensions according to the Nyquist theorem. Such a set can be used for compressive imaging.
Type (4): A subset of type (3) constructed from the type (2) patterns instead of the type (1) patterns.
Type (5): Any pattern set, which contains any of the patterns (1), (2), (3), or (4) as its subset(s).

In general, to allow imaging at several resolutions simultaneously, a full pattern set for high resolution should be selected in a way to contain at least two subsets that are themselves full pattern sets for low resolution imaging. If a high-resolution full pattern set contains just one such subset, a copy or copies of this subset can be added to the sequence of patterns projected onto the scene.

The following examples assume P=1 (single-pixel detector), but can be generalized for any P.

In some embodiments (such as the embodiment described above with reference to FIG. 2), the full pattern set may form a complete linearly independent basis for the high resolution imaging, and contain at least one subset (e.g. designated A in FIG. 2) that is itself a complete basis of a lower resolution. Examples of such basis sets are the Walsh-Hadmard, discrete cosine transform (variation of the Fourier transform), and Haar wavelet bases, but this is not exhaustive.

The particular example of FIG. 2(a) depicts a full pattern set where M=4×4=16, while subset A from FIG. 2(b) is itself a full pattern set for M=2×2=4. To obtain a low resolution image two times, a copy of subset A is added to the pattern set.

In the embodiments described above with respect to FIG. 5, the pattern set is also of type (1), but generated differently. In general, the pattern set contains individual patterns which are linear combinations of patterns from a complete basis of a lower resolution and other subsets. That allows reconstruction of a low-resolution image multiple times with just E patterns.

A method to generate such a pattern set can be as follows: first, a complete linearly independent basis set is chosen for the low resolution image (M pixels). Then, another complete basis is chosen for the sub-patterns (N pixels) that contains unbalanced basis patterns. Finally, the light patterns are constructed by taking a Kronecker product of the 2D basis functions from both sub-bases.

As a property of the Kronecker product, the final high resolution patterns also form a complete basis for a high resolution image (M×N pixels). Note that in this case, the final set of light patterns does not contain a subset that is a complete basis at a lower resolution, but instead is divisible into subsets that are approximations of such a basis.

In these embodiments, an approximation of a high resolution pattern (M×N pixels) is a low-resolution pattern (M pixels), obtained from the high resolution pattern by applying low pass frequency filtering and downsampling to low resolution (M pixels). An unbalanced pattern set is a set of linearly independent basis patterns where the average value of all pixels of any subpattern is different from the average value of all pixels of the unbalanced pattern set.

In various further embodiments, either the high resolution full pattern set or its subset(s) (used to reconstruct a low-resolution image) are of type 3. Such a pattern set can be used in conjunction with compressive imaging algorithms. These algorithms allow reconstructing an image using an incomplete basis of patterns, together with some prior knowledge or assumptions about the scene (obtained e.g. from previous frames), and usually yield lower quality images. For example, subset B or subset C from FIG. 2(b) are full pattern sets of type 3 for high-resolution imaging.

An example of a sequence in this case can be as follows:
1. Divide a full pattern set of type 1 into a number of subsets, such that at least two of those subsets are themselves a full pattern set of type 3.
2. Display the first subset and use compressive sensing with the result, giving a high-resolution low quality image. The image is then low-pass filtered and downsampled to obtain the low-quality low-resolution image.
3. The previous step is repeated with other subsets that are full pattern sets of type 3, and at each step a low-quality low-resolution image is obtained.
4. Information from all the subsets is used to construct a normal quality high-resolution image (without the use of compressive sensing).

Various other sequences are possible. For example, the initial high-resolution pattern set can also be of type 3, in which case the high-resolution image obtained at the last step will also be of low quality.

Some of the subsets could be full pattern sets of type 1 for low-resolution imaging (such as subset A of FIG. 2(b)), in which case a normal-quality low-resolution image is obtained at the corresponding step.

In the second step, instead of reconstructing a high-resolution image and downsampling, the patterns used for reconstruction can be low-resolution approximations of the patterns displayed, in which case a low-resolution image is reconstructed.

Although various embodiments have been described herein in terms of a method and system in which a scene is illuminated using a sequence of illumination patterns, it would also or instead be possible to use so-called “single pixel imaging” techniques (and/or similar related techniques) to achieve a corresponding effect. In these embodiments, the scene may be illuminated (e.g. evenly, i.e. without the use of illumination patterns), and the reflected light may be collected (e.g. using appropriate imaging optics).

A sequence of (detection) patterns may be imposed onto the reflected light, e.g. before the light is detected. This may be achieved in any suitable manner. For example, the detection patterns may be formed on the sensor, e.g. by a spatial light modulator arranged before (e.g. in front of) the sensor. Additionally or alternatively, the sensor may be configured to have active and/or inactive regions (and/or regions with different sensitivities), which regions may form patterns.

The detection patterns may be configured to have corresponding properties to the illumination patterns described above, mutatis mutandi.

Embodiments may be used, e.g., for 3D imaging for real-time 3D mapping of a vehicle's surroundings, e.g. to provide local situational awareness for self-driving or driver assist features.

A vehicle may require a 3D map for situational awareness that is a prerequisite to path planning and navigation. Different driving scenarios may require different (lateral) resolutions and reaction times.

For example, during maneuvering and parking the driving speed is slow and distances and dimensions of nearby objects (e.g. 0.5-10 m), especially on the road, need to be mapped at high resolution (e.g. 0.1 degrees angular resolution) but relatively low frame rate (e.g. few frames per second (fps)). On the other hand, cruising in city traffic requires detection of static and dynamic obstacles in short to medium range (e.g. 5-50 m) distances from the vehicle at relatively low resolution (e.g. 1 degree angular resolution) at a video frame rate (e.g. 20 fps), and with a field of view of 360 degrees around the vehicle. Driving at highway speeds requires high resolution images at a high frame rate in a narrow field of view, and simultaneously low resolution high frame rate images in a wide field of view (e.g. for detecting cars which change lanes unexpectedly). The sequence of illumination patters and the signal processing of various embodiments can be configured to provide each of these features.

Furthermore, the reflectivity of the objects in regular traffic situations and in different lighting conditions can vary on a large scale, ranging from retroreflectors that are designed to reflect back the majority of light, to dark objects with reflectivity less than 10% (dark objects). In accordance with various embodiments, dynamically controlled encoded illumination can be used to enable enhancement of the dynamic range of the detector, thereby allowing detection of the presence of the dark objects.

Embodiments can also be used, e.g. for real-time 3D mapping, e.g. for city infrastructure or an industrial site, e.g. to provide global situational awareness.

In infrastructure, a sensor that provides situational awareness in the form of a real-time 3D map, can be located e.g. at a height of ˜5 m height, so as to cover an area with an operational radius of, e.g. ˜50 m. In such a configuration, a uniform angular resolution may translate to about a 10 fold difference in the dimensions of detectable objects (i.e. relatively small objects may not be detectable at larger distances). The capability of selectively adjusting the resolution, in accordance with various embodiments, can be used to overcome this uniformity. In these embodiments, where the camera is static, the frame rate for imaging other static objects may be relatively low, while the frame rate for moving objects can be higher. Furthermore, the possibility of detecting moving objects allows the resolution of the camera to be adjusted, e.g. to an optimum, e.g. so as to allow reliable object recognition and fast object tracking.

Various embodiments may be provided as a fully functional 3D camera device (camera), e.g. that may be installed on a vehicle or anchored to an immovable object (e.g. lamp post). The camera can be designed to be connected to a central processing unit (CPU), e.g. via a standard digital interface (e.g. USB3.1 or PCI Express), and to accept commands from the CPU via this interface. The camera may output to the CPU the 3D image acquired during its operation and/or the 3D map of its field of view, e.g. which may include information about types, locations and dimensions of recognized objects.

In these embodiments, the camera acquisition parameters can be either controlled by the CPU directly, or automatically adjusted by the camera to optimize the image quality, e.g. as instructed by the CPU. The camera acquisition parameters can include, but are not limited to the following: frame rate of high-resolution image and its resolution, frame rate of low-resolution image and its resolution, dynamic range, field of view, region of interest (RoI), maximum measured distance, masked region (objects in which are not imaged).

Various embodiments may be provided as an optoelectronic subsystem (e.g. printed circuit board with components and electrical interfaces) of a 3D camera device, e.g. that can be installed into another product to enhance its functionality with the features described herein.

The subsystem may be configured to control an illumination source to illuminate the scene to be imaged, but may not include the multipixel photodetector (e.g. SPAD array), which may be installed on another product. The subsystem may receive information from the photodetector, e.g. via a digital interface, and may construct 3D images at a resolution higher than the photodetector's native resolution using this information.

The subsystem may provide these 3D images to another product, e.g. via another digital interface. The camera acquisition parameters (listed above) can be either controlled by the other product directly, or automatically adjusted by the subsystem, e.g. to optimize the image quality as instructed by the other product. The other product may or may not itself use the information from its photodetector to construct a 3D image with the native resolution of the photodetector.

FIG. 6 illustrates an imaging system configured in accordance with various embodiments that was used to determine distances in a three dimensional image. The system uses the direct time-of-flight (ToF) measurement method, where the time of emission of a light pulse and the detection time of that light pulse are recorded and then used to calculate the distance using the speed of light.

The lateral resolution of the three dimensional image was acquired using computational ghost imaging, where a known set of special light patterns were sequentially displayed onto a scene and the amount of light reflected from the scene from each pattern was measured using a single pixel light detector. Subsequently, the data from known patterns and the measured light was combined, allowing the computational reconstruction of an image of the scene.

The three-dimensional time-of-flight computational ghost imaging system as shown in FIG. 6 comprises a projection system 10 providing encoded illumination of the scene 40 using patterns, a detection system 20 for light detection, and a data processing unit 30 for image processing and reconstruction. The projection system 10 and the detection system 20 enable the system to implement the concept of pixel multiplexing, thereby increasing the number of pixels in the reconstructed image above the number of physical pixels in a line or a matrix sensor.

In the projection system 10 a beam of a pulsed picosecond laser 12 is directed onto a digital micromirror device 14 through a beam expander, and then projected onto a scene 40 using a lens 16. In the detection system 20, a cylindrical lens 26 allows each SPAD line sensor pixel 22 to collect the reflected light from a separate area of the scene 40 by narrowing each pixel's field of view. A 32 computer is used to control the measurements, and for data processing. The laser 12 also provided a reference signal for the SPAD line sensor 22, in order to enable direct time-of-flight measurements.

Prior to a measurement, the imaging system's projection system 10 can be programmed to display any desired pattern set, which enables the parameters of this setup to be controlled in software.

As illustrated in FIG. 7, the system illustrated in FIG. 6 was used for 3D imaging with a 256-pixel line sensor, and yielded a 64-fold increase in the number of pixels resulting in a 128×128 3D image. At the same time, a 64×64 3D image was reconstructed using only quarter of the full pattern set.

FIG. 7(a) shows a 2D image (photo) of a test scene. FIG. 7(b) illustrates a SPAD line sensor 22 image at its native sensor resolution of 1×256 pixels. FIG. 7(c) shows a reconstructed low-resolution (64×64) depth map, and FIG. 7(d) shows a reconstructed high-resolution (128×128) depth map. The depth resolution is 3 cm.

It can be seen from the above that the technology described herein, in its embodiments at least, provides a technique for providing high and low resolution images in an imaging system. This is achieved, in embodiments at least, by using detected reflections in respect of illumination patterns of a sequence to construct a first image of the scene having a first resolution, and using detected reflections in respect of a sub-set of illumination patterns of the sequence to construct a second image of the scene.

The foregoing detailed description has been presented for the purposes of illustration and description. It is not intended to be exhaustive or to limit the technology to the precise form disclosed. Many modifications and variations are possible in the light of the above teaching. The described embodiments were chosen in order to best explain the principles of the technology and its practical application, to thereby enable others skilled in the art to best utilise the technology in various embodiments and with various modifications as are suited to the particular use contemplated. It is intended that the scope be defined by the claims appended hereto.

1. A method of imaging a scene, the method comprising:
illuminating a scene; and
using a sensor to detect reflections from the scene in respect of each pattern of a sequence of patterns;
wherein the sequence of patterns is configured to allow a first image of the scene having a first resolution to be constructed, wherein the first resolution is greater than the resolution of the sensor;
wherein the sequence of patterns includes a first sub-set of patterns, wherein the first sub-set of patterns is configured to allow a second image of the scene having a second resolution to be constructed, and wherein the second resolution is less than the first resolution; and
wherein the method further comprises:
using detected reflections in respect of the patterns of the sequence to construct a first image of the scene having the first resolution; and
using detected reflections in respect of the first sub-set of patterns to construct a second image of the scene having the second resolution.

2. The method of claim 1, wherein the second resolution is greater than the resolution of the sensor.

3. The method of claim 1, wherein the method comprises:
illuminating the scene using a sequence of illumination patterns, and using the sensor to detect reflections from the scene in respect of each illumination pattern of the sequence.

4. The method of claim 1, wherein the method comprises:
using the sensor to detect reflections from the scene in respect of each detection pattern of a sequence of detection patterns.

5. The method of claim 1, wherein:
the sequence of patterns includes a full pattern set for constructing an image of the scene having the first resolution; and/or
the first sub-set of patterns includes a full pattern set for constructing an image of the scene having the second resolution.

6. The method of claim 1, wherein:
the first sub-set of patterns is arranged before the end of the sequence; and/or
wherein the method comprises constructing the second image before reflections have been detected in respect of all of the patterns of the sequence.

7. The method of claim 1, further comprising determining whether the second image has one or more properties, and controlling one or more subsequent patterns on the basis of the determination, wherein controlling one or more subsequent patterns on the basis of the determination comprises controlling one or more remaining patterns of the sequence on the basis of the determination and/or controlling one or more patterns of a subsequent sequence of patterns on the basis of the determination.

8. (canceled)

9. The method of claim 1, further comprising:
determining whether the second image includes one or more regions of interest and/or one or more undesired regions;
wherein when it is determined that the second image includes one or more regions of interest and/or one or more undesired regions, the method comprises:
altering the illumination intensity of one or more subsequent illumination patterns within the one or more regions of interest and/or one or more undesired regions; and/or
altering a detection intensity and/or efficiency of one or more subsequent detection patterns within the one or more regions of interest and/or one or more undesired regions.

10. The method of claim 9, wherein:
determining whether the second image includes one or more regions of interest and/or one or more undesired regions comprises determining whether the second image includes one or more bright regions;
wherein when it is determined that the second image includes one or more bright regions, the method comprises:
reducing the illumination intensity of one or more subsequent illumination patterns within the one or more bright regions; and/or
reducing the detection intensity and/or efficiency of one or more subsequent detection patterns within the one or more bright regions.

11. The method of claim 1, wherein:
the sequence of patterns includes a second sub-set of patterns, wherein the second sub-set of patterns is configured to allow a third image of the scene having a third resolution to be constructed, and wherein the third resolution is less than the first resolution; and
wherein the method further comprises using detected reflections in respect of the second sub-set of patterns to construct a third image of the scene having the third resolution.

12. The method of claim 11, wherein:
the second sub-set of patterns is arranged before the end of the sequence; and/or
wherein the method comprises constructing the third image before reflections have been detected in respect of all of the patterns of the sequence.

13. The method of claim 11, further comprising comparing the third image to the second image, and controlling one or more subsequent patterns on the basis of the comparison, and/or further comprising comparing the third image to the second image, and determining whether the scene includes a moving object on the basis of the comparison.

14. (canceled)

15. A non-transitory computer readable storage medium storing computer software code which when executing on a processor performs a method of imaging a scene, the method comprising:
illuminating a scene;
using a sensor to detect reflections from the scene in respect of each pattern of a sequence of patterns, wherein the sequence of patterns is configured to allow a first image of the scene having a first resolution to be constructed, wherein the first resolution is greater than the resolution of the sensor, and wherein the sequence of patterns includes a first sub-set of patterns, wherein the first sub-set of patterns is configured to allow a second image of the scene having a second resolution to be constructed, and wherein the second resolution is less than the first resolution;
using detected reflections in respect of the patterns of the sequence to construct a first image of the scene having the first resolution; and
using detected reflections in respect of the first sub-set of patterns to construct a second image of the scene having the second resolution.

16. An image processing system comprising:
a processing circuit configured to control the system such that reflections from a scene are detected in respect of a sequence of patterns; and
a processing circuit configured to receive information from a sensor that is configured to detect reflections from the scene in respect of each pattern of the sequence;
wherein the sequence of patterns is configured to allow a first image of the scene having a first resolution to be constructed, wherein the first resolution is greater than the resolution of the sensor;
wherein the sequence of patterns includes a first sub-set of patterns, wherein the first sub-set of patterns is configured to allow a second image of the scene having a second resolution to be constructed, and wherein the second resolution is less than the first resolution; and
wherein the system further comprises a processing circuit configured to:
use detected reflections in respect of the patterns of the sequence to construct a first image of the scene having the first resolution; and
use detected reflections in respect of the first sub-set of patterns to construct a second image of the scene having the second resolution.

17. An imaging system comprising:
one or more sources configured to illuminate a scene; and
a sensor configured to detect reflections from the scene in respect of each pattern of a sequence of patterns; wherein the sequence of patterns is configured to allow a first image of the scene having a first resolution to be constructed, wherein the first resolution is greater than the resolution of the sensor;
wherein the sequence of patterns includes a first sub-set of patterns, wherein the first sub-set of patterns is configured to allow a second image of the scene having a second resolution to be constructed, and wherein the second resolution is less than the first resolution; and
wherein the system further comprises a processing circuit configured to:
use detected reflections in respect of the patterns of the sequence to construct a first image of the scene having the first resolution; and
use detected reflections in respect of the first sub-set of patterns to construct a second image of the scene having the second resolution.

18. (canceled)

19. The system of claim 16, wherein:
the one or more sources are configured to illuminate the scene using a sequence of illumination patterns, and the sensor is configured to detect reflections from the scene in respect of each illumination pattern of the sequence; and/or
the sensor is configured to detect reflections from the scene in respect of each detection pattern of a sequence of detection patterns.

20. (canceled)

21. The system of claim 16, wherein:
the sequence of patterns includes a full pattern set for constructing an image of the scene having the first resolution; and/or
the first sub-set of patterns includes a full pattern set for constructing an image of the scene having the second resolution.

22. (canceled)

23. The system of any one of claim 16, wherein the system is configured to determine whether the second image has one or more properties, and to control one or more remaining patterns of the sequence on the basis of the determination and/or to control one or more patterns of a subsequent sequence of patterns on the basis of the determination.

24. (canceled)

25. (canceled)

26. The system of claim 16, wherein:
the sequence of patterns includes a second sub-set of, wherein the second sub-set of patterns is configured to allow a third image of the scene having a third resolution to be constructed, and wherein the third resolution is less than the first resolution; and
wherein the system is configured to use detected reflections in respect of the second sub-set of patterns to construct a third image of the scene having the third resolution.

27. The system of claim 26, wherein:
the second sub-set of patterns is arranged before the end of the sequence; and/or
the system is configured to construct the third image before the scene has been illuminated with all of the patterns of the sequence; and/or
the system is configured to construct the third image before reflections have been detected using all of the detection patterns of the sequence of detection patterns.

28. (canceled)

29. (canceled)
